(19) United States
(12) Patent Application Publication
(10) Pub. No.: US 2016/0063487 A1
(43) Pub. Date: Mar. 3, 2016

(54) SYSTEM AND METHOD FOR DOUBLE BLIND AUTHENTICATION

(71) Applicant: Capital One Services, LLC, McLean, VA (US)

(72) Inventor: Paul Young MORETON, Glen Allen, VA (US)

(21) Appl. No.: 14/840,138

(22) Filed: Aug. 31, 2015

Related U.S. Application Data
(60) Provisional application No. 62/043,567, filed on Aug. 29, 2014.

(51) Int. Cl. G06Q 20/36; G06Q 20/20; G06Q 20/40

(52) U.S. Cl. CPC G06Q 20/3674; G06Q 20/4012; G06Q 20/20

(57) ABSTRACT

A system and method a method for providing a double blind payment by virtually authorizing a transaction using an additional Funding Personal Account Number (FPAN). The method may include generating, by an issuing entity, an additional FPAN (e.g., FPAN2, FPAN3, etc.) that is tied to a primary account for a customer and independent from the number printed on the face of the transaction card associated with the master account. The additional FPAN may be associated with a specific merchant, a specific type of payment (e.g., online purchase, in-store purchase, and the like), and/or a specific account holder (e.g., master account holder, subsidiary account holder, and the like). The method may include receiving, at a merchant point-of-sale (PoS) system, the additional FPAN token, transmitting the additional FPAN token to the authorizing party, converting the additional FPAN token to the primary account number associated with the transaction card for authorization and approval of the charges, and transmitting, from the authorizing party to the merchant, the approval and authentication determination and additional FPAN number associated with the approval and authentication determination.

### CROSS-REFERENCE TO RELATED APPLICATIONS

This application contains subject matter related to and claims the benefit of U.S. Provisional Patent Application No. 62/043,567, filed on Aug. 29, 2014, the entire contents of which is incorporated herein by reference.

### FIELD OF DISCLOSURE

The present disclosure relates to systems and methods for providing a double blind payment by programming a transaction authorization system to virtually authorize a transaction using a Funding Personal Account Number (FPAN).

### BACKGROUND OF THE DISCLOSURE

Tokenization includes substituting a sensitive data element with a special purpose substitute. Tokenization may be used for protecting sensitive data involving, for example, account data associated with a financial institution. During tokenization in financial transactions, a token is mapped to a Funding Personal Account Number (FPAN), where the FPAN is the card number printed on the face of a transaction card such as a credit card. The FPAN is subject to compromise.

These and other drawbacks exist.

### SUMMARY OF THE DISCLOSURE

In an example embodiment, the present disclosure is directed to a method for providing a double blind payment by virtually authorizing a Funding Personal Account Number (FPAN) transaction via a token using a specifically-programmed transaction authorization system. The method may include generating, by an issuing entity, an additional FPAN (e.g., FPAN2, FPAN3, etc.) that is tied to or otherwise associated with a master account for a customer and independent from the number printed on the face of the transaction card associated with the master account. The additional FPAN may be associated with a specific merchant, a specific type of payment (e.g., online purchase, in-store purchase, and the like), and/or a specific account holder (e.g., master account holder, subsidiary account holder, and the like). The method also may include assigning an additional FPAN (e.g., FPAN2, FPAN3, etc.) to a specific merchant, such that the additional FPAN token (FPAN-t) is unique to the merchant and account holder pair. The method may include storing, by a merchant, the additional FPAN-t, using, by the merchant, the additional FPAN-t in the authentication and approval of charges between the account holder and the merchant, and storing, by the merchant, all charges against the additional FPAN-t. The method may include receiving, at a merchant point-of-sale (PoS) system, the additional FPAN-t, transmitting the additional FPAN-t to the authorizing party (e.g., Visa, MasterCard, American Express, and the like), converting, by the authorizing party and/or financial institution, the additional FPAN-t to the original number (FPAN2) associated with the transaction card for authorization and approval of the charges, and transmitting, from the authorizing party to the merchant, the approval and authentication determination and additional FPAN number associated with the approval and authentication determination. In this manner, the original FPAN number associated with the transaction card of the customer is never used, discoverable, and/or seen by the customer and/or the merchant. Instead, the additional FPAN-t number is used and/or seen by the customer and/or merchant.

In various aspects, multiple additional FPAN-t(s) associated with the same account may be issued to the same merchant so that each additional FPAN-t is associated with a particular type of merchant transaction (e.g., an in-store purchase, an online purchase, and the like).

In various aspects, a customer may provide payment using a computer, a mobile device, a smart card, an NFC-enabled device, a transaction card, or the like. In various aspects, a customer may provide payment for a purchase made using a website, a mobile application, a PoS device, and the like.

In various aspects, an additional FPAN is tied to a master account, where multiple customers may be associated with the master account and each customer is associated with a separate additional FPAN. In this manner, a master account holder may be associated with FPAN2, and a subsidiary account holder may be associated with FPAN3.

In various aspects, the method includes wherein the authorizing and/or approving system is associated with a financial services institution.

### BRIEF DESCRIPTION OF THE DRAWINGS

Various embodiments of the present disclosure, together with further objects and advantages, may best be understood by reference to the following description taken in conjunction with the accompanying drawings, in the several figures of which like reference numerals identify like elements, and in which:

FIG. 1 is a diagram illustrating an example system for virtually authorizing a transaction using a FPAN, consistent with various embodiments;

FIG. 2 is a diagram illustrating an example system for virtually authorizing a transaction using a FPAN, consistent with various embodiments;

FIG. 3 is a diagram illustrating an example system for virtually authorizing a transaction using a FPAN, consistent with various embodiments;

FIG. 4 is a diagram illustrating an example system for virtually authorizing a transaction using a FPAN, consistent with various embodiments; and

FIG. 5 is a flowchart illustrating an example method for virtually authorizing a transaction using a FPAN, consistent with various embodiments.

### DETAILED DESCRIPTION OF THE DISCLOSURE

The following description is intended to convey a thorough understanding of the embodiments described by providing a number of specific example embodiments and details involving systems and methods for providing a double blind payment by virtually authorizing a transaction using a Funding Personal Account Number (FPAN). It should be appreciated, however, that the present disclosure is not limited to these specific embodiments and details, which are examples only. It is further understood that one possessing ordinary skill in the art, in light of known systems and methods, would appreciate the use of the invention for its intended purposes and benefits in various embodiments, depending on specific design and other needs. A financial services institution and systems supporting a financial institution are used in the examples of the disclosure. However, the disclosure is not intended to be limited to financial services institutions only. Instead, the disclosed system and method can be extended to any entity that seeks to provide a double blind payment by virtually authorizing a transaction using a Funding Personal Account Number (FPAN) without departing from the spirit and scope of the disclosure.

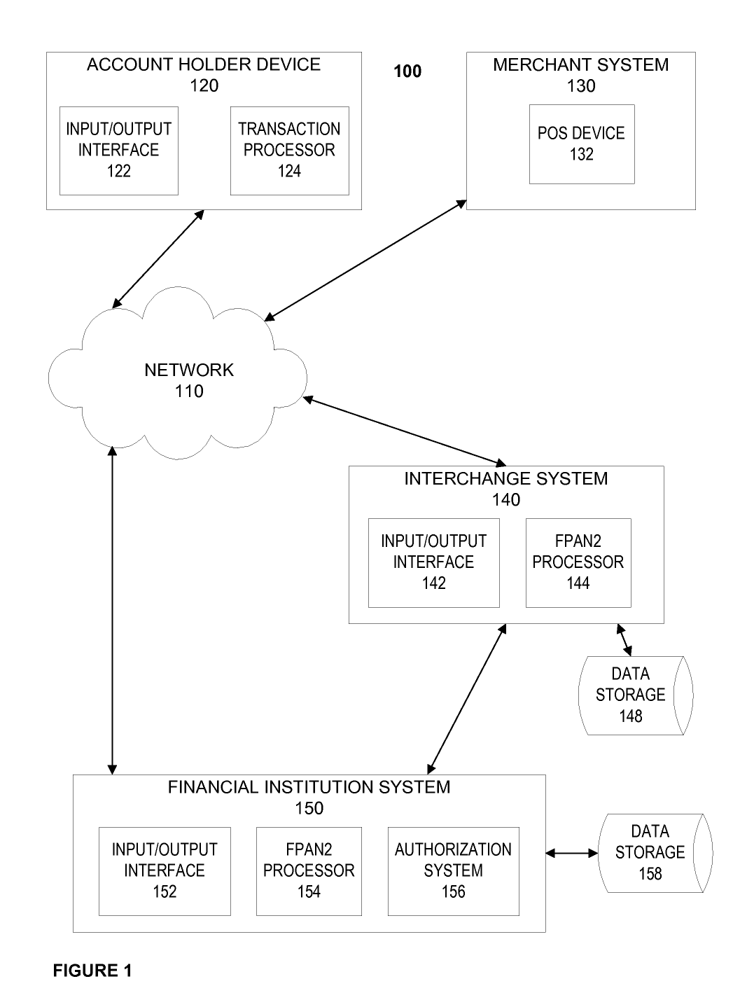

According to the various embodiments of the present disclosure, systems and methods are disclosed for providing a double blind payment by virtually authorizing a transaction using a Funding Personal Account Number (FPAN) using an authorization system that is specifically programmed to authorize such transactions. A double blind payment may include a payment where the additional FPAN (e.g., FPAN2, FPAN3, etc.) is never exposed to or discoverable by outside merchants, networks, and/or acquirers. In this manner, the merchant and the customer are unaware of the account number being used in the transaction. The systems and methods depicted in, for example, FIGS. 1 through 5 allow an account holder to transmit a tokenized additional FPAN to a merchant without disclosing the primary account number associated with the additional FPAN to the merchant and/or account holder systems. In an example embodiment, the systems and methods of the disclosure may be configured to operate in connection with an account holder device (e.g., a smartphone, an electronic reader, a laptop computer, etc. a set top box, a cable card, etc.) that allows a user to transact with a merchant system. In such an embodiment, the merchant system may include one or more software applications stored in memory to perform transactions and transmit data to an association/interchange system for transaction processing. The systems and methods may further include one or more corresponding system applications and one or more cloud-based services, which may be operated by data service providers, financial institution systems, and the like, for example. In the disclosed embodiments, the illustrative data provider may be a financial services institution. The data provider also may be any type of entity that provides data to a user via a user device.

FIG. 1 is a diagram illustrating an example system for virtually authorizing a transaction using an additional funding personal account number (FPAN), according to the various embodiments. As shown in FIG. 1, an example system 100 may include one or more account holder devices 120, one or more merchant systems 130, one or more interchange systems 140, and one or more financial institution systems 150 connected over one or more networks 110.

For example, network 110 may be one or more of a wireless network, a wired network or any combination of wireless network and wired network. For example, network 110 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal.

In addition, network 110 may include, without limitation, telephone lines, fiber optics, IEEE Ethernet 902.3, a wide area network (“WAN”), a local area network (“LAN”), or a global network such as the Internet. Also network 140 may support an Internet network, a wireless communication network, a cellular network, or the like, or any combination thereof. Network 110 may further include one network, or any number of the example types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

Account holder device 120 may be any type of computer, handheld device, and/or transaction card (not pictured). Merchant system 130 may include any type of computer and/or processing system for processing merchant-related transactions. Interchange system 140 may include a consumer payment system whose members are the financial institutions that issue payment cards and/or sign merchant to accept payment cards. Example interchange systems 140 may include systems associated with, for example, Visa®, MasterCard®, AmericanExpress®, Discover® and the like. Interchange system 140 may include one or more computer systems and networks to process transactions. Financial institution system 150 may include systems associated with financial institutions that issue payment cards and maintains a contract with cardholders for repayment. In various embodiments, a financial institution 150 may issue credit, debit, and/or stored value cards, for example. Financial institution 150 may include, by way of example and not limitation, depository institutions (e.g., banks, credit unions, building societies, trust companies, mortgage loan companies, pre-paid gift cards or credit cards, etc.), contractual institutions (e.g., insurance companies, pension funds, mutual funds, etc.), investment institutions (e.g., investment banks, underwriters, brokerage funds, etc.), and other non-bank financial institutions (e.g., pawn shops or brokers, cashier's check issuers, insurance firms, check-cashing locations, payday lending, currency exchanges, microloan organizations, crowd-funding or crowd-sourcing entities, third-party payment processors, etc.). Example financial institutions may include, Capital One, Bank of America, Citibank, Wells Fargo, Sub Trust, various community banks, and the like.

For example, account holder devices 120, merchant systems 130, interchange systems 140, and/or financial institution systems 150 may include, for example, one or more mobile devices, such as, for example, personal digital assistants (PDA), tablet computers and/or electronic readers (e.g., iPad, Kindle Fire, Playbook, Touchpad, etc.), wearable devices (e.g., Google Glass), telephony devices, smartphones, cameras, music playing devices (e.g., iPod, etc.), televisions, set-top-box devices, and the like. Account holder devices 120, merchant systems 130, interchange systems 140, and/or financial institution systems 150 also may include a network-enabled computer system and/or device. As referred to herein, a network-enabled computer system and/or device may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The network-enabled computer systems may execute one or more software applications to, for example, receive data as input from an entity accessing the network-enabled computer system, process received data, transmit data over a network, and receive data over a network. Account holder devices 120, merchant systems 130, interchange systems 140, and/or financial institution systems 150 may include at least one central processing unit (CPU), which may be configured to execute computer program instructions to perform various processes and methods. Account holder devices 120, merchant systems 130, interchange systems 140, and/or financial institution systems 150 may include data storage, including for example, random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

Account holder device 120, merchant system 130, interchange system 140, and/or financial institution system 150 may further include, for example, a processor, which may be several processors, a single processor, or a single device having multiple processors. Although depicted as single elements, it should be appreciated that according to one or more embodiments, account holder device 120, merchant system 130, interchange system 140, and/or financial institution system 150 may comprise a plurality of account holder devices 120, merchant systems 130, interchange systems 140, and/or financial institution systems 150.

Account holder device 120, merchant system 130, interchange system 140, and/or financial institution may further include data storage (e.g., data storage 148, 158). The data storage may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, or any other storage mechanism.

As shown in FIG. 1, each account holder device 120, interchange system 140, and/or financial institution 150 may include various components. As used herein, the term “component” may be understood to refer to computer executable software, firmware, hardware, or various combinations thereof. It is noted that the modules shown and described herein are intended as examples. The components may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

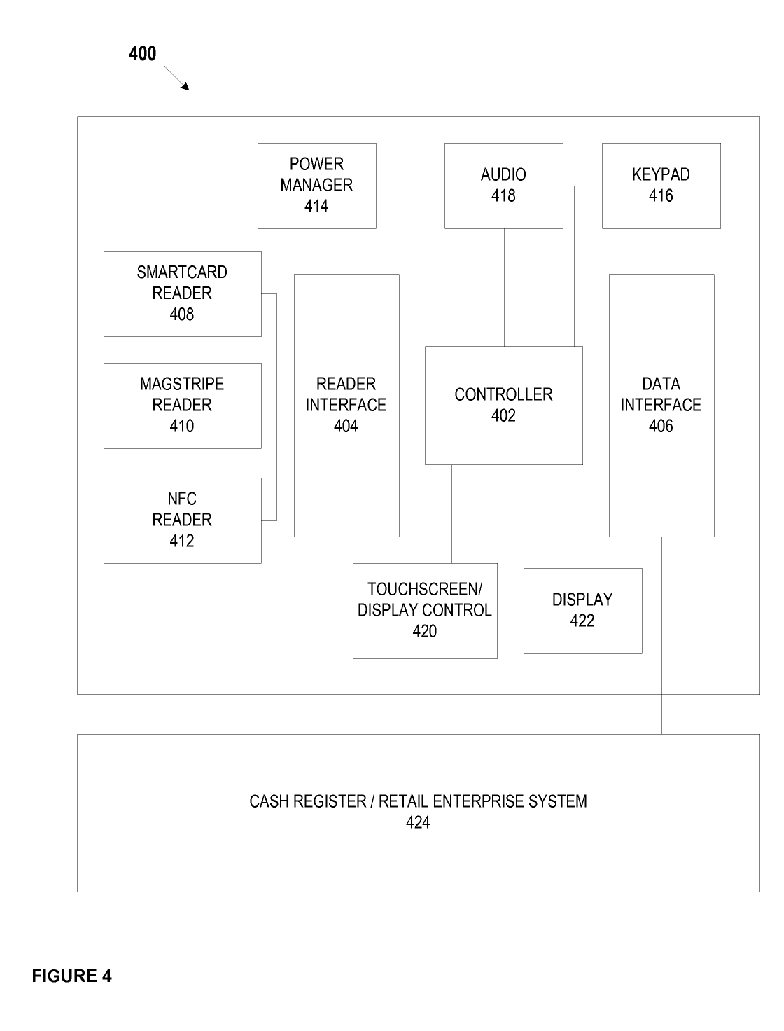

Account holder device 120 may include, for example, an input/output interface 122 and a transaction processor 124. Where, for example, the account holder device 120 is a transaction card, the transaction card may be operable to communicate with a merchant system 130, including a Point of Sale (PoS) device, as described with respect to FIG. 4 below. Input/output interface 122 may enable communication between the components of system 100. Input/output interface 122 may include hardware, software, and/or firmware that may enable communication between account holder device 120 and merchant system 130. For example, input/output interface 122 may include an input/output interface and input/output devices driven by a processor. An input/output device and/or interface may include, for example, a transceiver, modems, network interfaces, buses, CD-ROM, keyboard, mouse, microphone, camera, touch screen, printers, USB flash drives, speakers, and/or any other device configured to receive and transmit electronic data. Input/output interface 122 may include for example, I/O devices, which may be configured to provide input and/or output to client device 120 (e.g., keyboard, mouse, display, speakers, printers, modems, network cards, etc.). Input/output interface 122 also may include antennas, network interfaces that may provide or enable wireless and/or wire line digital and/or analog interface to one or more networks, such as network 110, over one or more network connections, a power source that provides an appropriate alternating current (AC) or direct current (DC) to power one or more components of account holder device 120, and a bus that allows communication among the various components of account holder device 120. Input/output interface 122 may include a display, which may include for example output devices, such as a printer, display screen (e.g., monitor, television, and the like), speakers, projector, and the like. Although not shown, each account holder device 120 may include one or more encoders and/or decoders, one or more interleavers, one or more circular buffers, one or more multiplexers and/or de-multiplexers, one or more permuters and/or depermuters, one or more encryption and/or decryption units, one or more modulation and/or demodulation units, one or more arithmetic logic units and/or their constituent parts, and the like.

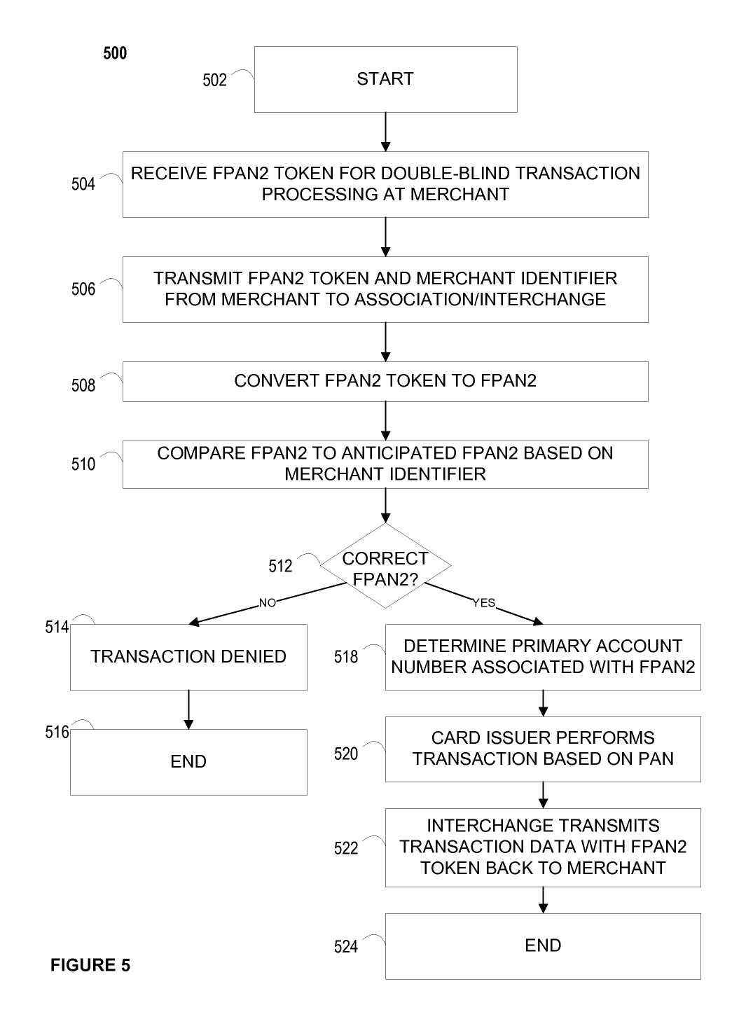

Transaction processor 124 may include hardware and/or software to enable transaction processing using a payment method as described with reference, for example, to FIG. 5. For example, transaction processor 124 may include at least one processor configured to transmit an additional FPAN token (e.g., FPAN2 token, FPAN3 token) for double blind payment using, for example a FPAN2 token. Transaction processor 124 may include at least one processor configured to transmit a transaction result from a merchant system 130 to the account holder device 120 where a transaction result may include, transaction approved or transaction denied.

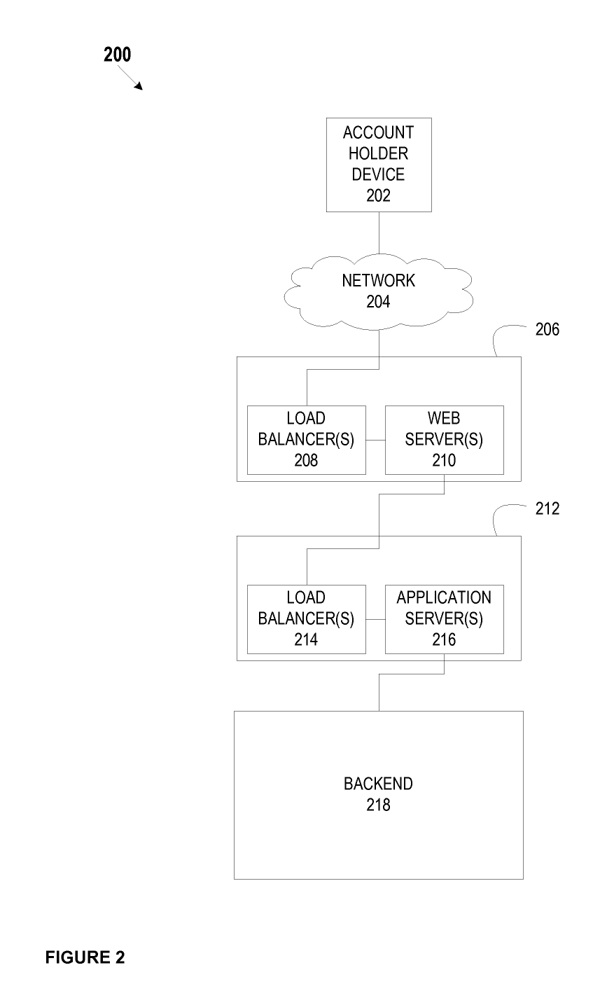

Merchant system 130 may include, among other components, a PoS device 132. PoS device 132 may include a variety of readers to read transaction data including, for example FPAN2 token data. PoS device may include various hardware and/or software components required to conduct and process transaction, such as components described throughout FIGS. 2, 3, and 4. Merchant system 130 may also include data storage (not shown) to store additional FPAN tokens and approval of charges between an account holder and the merchant associated with a particular FPAN token.

Interchange system 140 and/or financial institution system 150 may include various software and/or hardware components operable to enable an input/output interfaces 142, 152, a FPAN2 processors 144, 154, and/or an authorization processor 156. Input/output interfaces 142 and 152 may include may enable communication between the components of system 100. Input/output interfaces 144, 154 may include hardware, software, and/or firmware that may enable communication between interchange system 140 and financial institution system 150. For example, input/output interfaces 142, 152 may include an input/output interface and input/output devices driven by a processor. An input/output device and/or interface may include, for example, a transceiver, modems, network interfaces, buses, CD-ROM, keyboard, mouse, microphone, camera, touch screen, printers, USB flash drives, speakers, and/or any other device configured to receive and transmit electronic data. Input/output interfaces 142, 152 may include for example, I/O devices, which may be configured to provide input and/or output inter change system 140 and/or financial institution system 150 (e.g., keyboard, mouse, display, speakers, printers, modems, network cards, etc.). Input/output interfaces 142, 152 also may include antennas, network interfaces that may provide or enable wireless and/or wire line digital and/or analog interface to one or more networks, such as network 110, over one or more network connections, a power source that provides an appropriate alternating current (AC) or direct current (DC) to power one or more components of interchange system 140 and/or financial institution system 150, and a bus that allows communication among the various components of interchange system 140 and/or financial institution system 150. Input/output interfaces 142, 152 may include a display, which may include for example output devices, such as a printer, display screen (e.g., monitor, television, and the like), speakers, projector, and the like. Although not shown, interchange system 140 and/or financial institution system 150 may include one or more encoders and/or decoders, one or more interleavers, one or more circular buffers, one or more multiplexers and/or de-multiplexers, one or more permuters and/or depermuters, one or more encryption and/or decryption units, one or more modulation and/or demodulation units, one or more arithmetic logic units and/or their constituent parts, and the like.

FPAN2 processor 144, 154 may be maintained at or by interchange system 140 and/or financial institution system 150, alone or in combination. FPAN2 processor may convert an additional FPAN token (e.g., FPAN2 token, FPAN3 token, etc.) to the FPAN2 and compare the FPAN2 to the anticipated FPAN2 associated with the merchant involved in the transaction. An additional FPAN (e.g., FPAN2, FPAN3, etc.) may be a virtual number that is tokenized for financial transactions. Accordingly, the original number associated with and printed on a transaction card (e.g., debit card, credit card, etc.) is never disclosed between the merchant and the account holder.

The additional FPAN, e.g., FPAN2, may be associated with a specific merchant and/or a specific type of transaction. For example, a first merchant may be associated with a first FPAN2, while a second merchant may be associated with a second FPAN2. Moreover, a merchant may be associated with a first additional FPAN (e.g., FPAN2) when a transaction is an in-person PoS transaction, while the same merchant may be associated with a second additional FPAN (e.g., FPAN3) when a transaction is an e-commerce (e.g., online, mobile application, and the like) transaction. Moreover, a first account holder making a purchase at a first merchant may be issued a first additional FPAN (e.g., FPAN2) while a subsidiary account holder making a purchase at a first merchant may be issued a second additional FPAN (e.g., FPAN3). In this manner, the additional FPAN(s) may be associated with a respective specific merchant, a specific type of payment (e.g., online purchase, in-store purchase, and the like), and/or a specific account holder (e.g., master account holder, subsidiary account holder, and the like).

Accordingly, an FPAN processor 144, 154 may convert the tokenized FPAN2 to the FPAN2 and compare the received FPAN2 to the anticipated FPAN2 associated with the merchant involved in the transaction. This conversion and/or comparison may occur at either the interchange system 140 and/or the financial institution system 150. While FPAN2 is used in the examples, any additional FPAN may be used (e.g., FPAN3, FPAN4, etc.).

When the conversion and comparison occurs at the FPAN2 processor 144 maintained at or by the interchange system 140, the interchange system 140 may look up the primary account number associated with the FPAN2 in data storage 148 and transfer the primary account number associated with the FPAN2 to the financial institution system 150 for transaction processing via the input/output module 142. Additionally, when the conversion and comparison occurs at the interchange system 140, the interchange system 140 may determine whether the FPAN2 is the anticipated FPAN2 for the merchant associated with the transaction using the FPAN2 processor 144 and transmit an approval or denial to the merchant system 130 and/or account holder device 120 via network 110.

When the conversion and comparison occurs at the FPAN2 processor 154 maintained at or by the financial institution system 150, the financial institution system 150 may look up or otherwise identify the primary account number associated with the FPAN2 in data storage 158 and transfer the primary account number associated with the FPAN2 to authorization processor 156 for transaction processing. When the conversion and comparison occurs at the financial institution system 150, the financial institution system 150 may determine whether the FPAN2 is the anticipated FPAN2 for the merchant associated with the transaction using the FPAN2 processor 154 and transmit an approval or denial to the merchant system 130 and/or account holder device 120 via network 110. Authorization processor 156 may include at least one processor and associated data storage 158 required to authorize and approve a transaction when the financial institution system 150 and/or interchange system 140 determine that the correct FPAN2 number is associated with the transaction. For example, transaction approval may occur as describe herein with respect to, for example, FIGS. 2 through 4.

In one or more implementations of the components of FIG. 1, the functions described may be implemented in hardware, software, firmware, or any combination thereof. If implemented in software, the functions may be stored as one or more instructions or code on computer-readable medium, including the computer-readable medium described above (e.g., RAM, ROM, storage media, and the like.).

Although FIG. 1 depicts account holder device 120, merchant system 130, interchange system 140, and/or financial institution system 150 communicating with one another using an indirect network connection, such as a connection through network 110, those skilled in the art may appreciate that account holder device 120, merchant system 130, interchange system 140, and/or financial institution system 150 may communicate with one another and similar devices using a direct communications link or a communications link separate from network 110. For example, account holder device 120, merchant system 130, interchange system 140, and/or financial institution system 150 may communicate with one another via point-to-point connections (e.g., Bluetooth connections, etc.), peer-to-peer connections, and the like. By way of example, account holder device 120, merchant system 130, interchange system 140, and/or financial institution system 150 may communicate with one another via mobile contactless communication and/data transfers, remote electronic communication and/data transfers, magnetic stripe communication and/data transfers, secure chip technology communication and/data transfers, person-to-person communication and/data transfers, and the like. Additionally, account holder device 120, merchant system 130, interchange system 140, and/or financial institution system 150 may communicate with one another utilizing standardized transmission protocols, for example and not by way of limitation, ISO/IEC 14443 A/B, ISO/IEC 18092, MiFare, FeliCa, tag/smartcard emulation, and the like. Also server account holder device 120, merchant system 130, interchange system 140, and/or financial institution system 150 may communicate with one another utilizing transmission protocols and methods that are developed in the future using other frequencies or modes of transmission. Account holder device 120, merchant system 130, interchange system 140, and/or financial institution system 150 may communicate with one another via existing communication and/data transfer techniques, such as, for example RFID. Also account holder device 120, merchant system 130, interchange system 140, and/or financial institution system 150 may communicate with one another via new and evolving communication and/data transfer standards including internet-based transmission triggered by near-field communications (NFC).

In the embodiment of FIG. 1, account holder device 120, merchant system 130, interchange system 140, and/or financial institution system 150 may communicate using standard Internet Protocols, such as HTTP and/or HTTPS, transmission control protocol (TCP), internet protocol (IP), etc. For example, HTTPS requests from account holder device 120, merchant system 130, interchange system 140, and/or financial institution system 150 may be encapsulated in TCP segments, IP datagrams, and Ethernet frames and transmitted to account holder device 120, merchant system 130, interchange system 140, and/or financial institution system 150. Third parties, for example, may participate as intermediaries in the communication, such as, for example, Internet Service Providers (ISPs) or other entities that provide routers and link layer switches. Such third parties may not, however, analyze or review the contents of the Ethernet frames beyond the link layer and the network layer, but instead analyze only those parts of the packet necessary to route communications among and between from account holder device 120, merchant system 130, interchange system 140, and/or financial institution system 150.

FIG. 2 depicts an example account holder system. The example system 200 in FIG. 2 may enable a financial institution, for example, to provide network services to its customers. As shown in FIG. 2, system 200 may include an account holder device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

Account holder device 202 may be a network-enabled computer: As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

Account holder device 202 also may be a mobile device. For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device. Account holder device 202 also may be similar to account holder device 120 as shown and described in FIG. 1.

Network 204 may be one or more of a wireless network, a wired network, or any combination of a wireless network and a wired network. For example, network 204 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN) or a global network such as the Internet. Also, network 204 may support an Internet network, a wireless communication network, a cellular network, or the like, or any combination thereof. Network 204 may further include one network, or any number of example types of networks mentioned above, operating as a stand-alone network or in cooperation with each other. Network 204 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 210 may distribute workloads across, for example, web server(S) 216 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 may include software that monitoring the port where external clients, such as, for example, account holder device 202, connect to access various services of a financial institution, for example. Load balancer(s) 208 may forward requests to one of the application servers 216 and/or backend 218 servers, which may then reply to load balancer 208. This may allow load balancer(s) 208 to reply to account holder device 202 without account holder device 202 ever knowing about the internal separation of functions. It also may prevent account holder devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP/HTTPS compression; TCP offloading; TCP buffering; direct server return; health checking; HTTP/HTTPS caching; content filtering; HTTP/HTTPS security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., account holder device 202) through a network (e.g., network 204), such as the Internet. In various examples, web servers, may deliver web pages, relating to, for example, online banking applications and the like, to clients (e.g., account holder device 202). Web server(s) 210 may use, for example, a hypertext transfer protocol (HTTP/HTTPS or sHTTP) to communicate with account holder device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP/HTTPS and web server 210 may respond with the content of that resource or an error message if unable to do so. The resource may be, for example a file on stored on backend 218. Web server(s) 210 also may enable or facilitate receiving content from account holder device 202 so account holder device 202 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution or other entity implementing system 200, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 216 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution or other entity that maintains a distributed system similar to system 200. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, and the like. Backend 218 may be associated with various databases, including account databases that maintain, for example, customer account information, product databases that maintain information about products and services available to customers, content databases that store content associated with, for example, a financial institution, and the like. Backend 218 also may be associated with one or more servers that enable the various services provided by system 200. Backend 218 may enable a financial institution, for example, to implement the double blind payment authorization methods as shown and described herein.

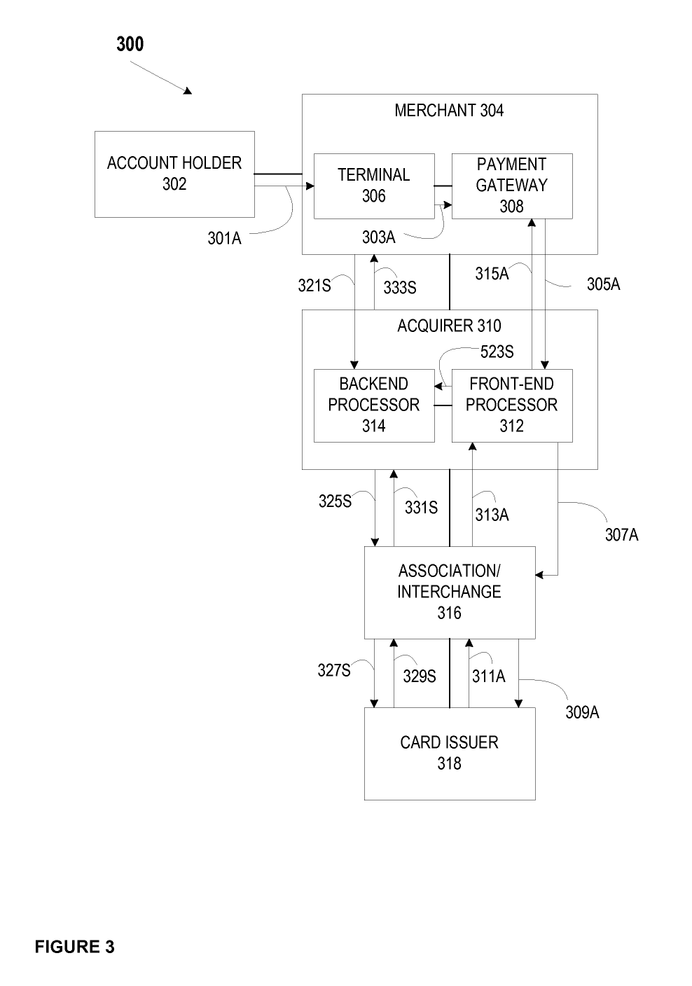

FIG. 3 illustrates an example system 300 and method for transaction authorization. As shown and described in FIG. 3, merchants, account holders and financial institutions may be connected with a card association network to enable secure transactions and timely payments. System 300 may include a cardholder 302, merchant 304, Acquirer 310, Association/Interchange 316, and card issuer 318.

Cardholder 302 may be any card holder, including a credit card holder, debit card holder, stored value card holder and the like. Cardholder 302 may possess a plastic card or carry a device (e.g., a mobile device) that securely stores card credentials and is capable of transmitting the card credentials to, for example, a PoS terminal (e.g., terminal 306). Cardholder 302 may interact with a merchant (e.g., merchant 304) by presenting a card or card credentials to a terminal (e.g., terminal 306).

Merchant 304 may be any merchant that accepts payment from a cardholder, for example. Merchant 304 may be any retailer, service provider, business entity, or individual that accepts payments. Merchant 304 may include software, firmware and hardware for accepting and/or processing payments. For example, as illustrated in FIG. 3, merchant 304 may include a terminal 306 and a payment gateway 308. Terminal 306 and payment gateway 308 may comprise the physical or virtual device(s) used by merchant 304 to communicate information to front-end processor 312 of acquirer 310. Terminal 306 may be similar to a PoS system. In various embodiments, payment gateway 308 may be an e-commerce application service provider service that authorizes payments for merchants. As such, payment gateway 308 may be a virtual equivalent of a PoS terminal and interface with, for example, a billing system of merchant 304 and pass data to front-end processor 312 of acquirer 310.

Acquirer 310 may be, for example, a financial institution or bank that holds the contract for providing payment processing services to merchant 304. Merchant 304 may have a merchant account that may serve as a contract under which Acquirer 310 may extend a line of credit to a merchant who wishes to accept, for example, credit card transactions. As shown in FIG. 3, Acquirer 310 may be associated with front-end processor 312 and back-end processor 314.

In various examples, front-end processor 312 may be a platform that card terminal 306 and/or payment gateway 308 communicate with when approving a transaction. Front-end processor 312 may include hardware, firmware, and software to process transactions. Front-end processor 312 may be responsible for the authorization and capture portion of credit card transaction. Front-end processor 312 also may include additional front-end platform interconnections to support, for example, ACH and debit transactions.

Backend processor 314 may be a platform that takes captured transactions from front-end processor 312 and settles them through an Interchange system (e.g., association/interchange 316). Back-end processor 314 may generate, for example, daily ACH files for merchant settlement. Back-end processor 314 also may handle chargeback handling, retrieval request and monthly statements.

Association/interchange 316 may be the consumer payment system whose members are the financial institutions that issue payment cards and/or sign merchant to accept payment cards. Example associations/interchanges 316 may include, Visa®, MasterCard®, and American Express®. Association/interchange 316 may include one or more computer systems and networks to process transactions.

Issuer 318 may be a financial institution that issues payment cards and maintains a contract with cardholders for repayment. In various embodiments, issuer 318 may issue credit, debit, and/or stored value cards, for example. Example issuers may include, Capital One, Bank of America, Citibank, and the like.

In various embodiments, processing a payment card transaction may involve two stages: (1) authorization and (2) clearing and settlement. Authorization may refer to an electronic request that is sent through various parties to either approve or decline the transaction. Clearing and Settlement may refer to settlement of the parties' settle accounts to enable the parties to get paid.

During authorization, cardholder 302 may present payment card as payment (301A) at merchant 304 PoS terminal 306, for example. Merchant 304 may enter card into a physical PoS terminal 306 or submit a credit card transaction to a payment gateway 308 on behalf of cardholder 302 via secure connection from a Web site, retail location, or a wireless device.

Payment gateway 308 may receive the secure transaction information (303A) and may pass the secure transaction information (305A) via a secure connection to the merchant acquirer's 310 front-end processor 312.

Front-end processor 312 may submit the transaction (307A) to association/interchange 316 (e.g., a network of financial entities that communicate to manage the processing, clearing and settlement of credit card transactions). Association/interchange 316 may route the transaction (309A) to the customer's Issuer 318. Issuer 318 may approve or decline the transaction and passes the transaction results back (311A) through association/interchange 316. Association/interchange then may relay the transaction results (313A) to front-end processor 512.

Front-end processor 312 may relay the transaction results (315A) back to the payment gateway 308 and/or terminal 306. Payment gateway 308 may store the transaction results and sends them to merchant 304. Merchant 304 may receive the authorization response and complete the transaction accordingly.

During settlement, merchant 304 may deposit the transaction receipt (321 S) with acquirer 310 via, for example, a settlement batch. Captured authorizations may be passed (323S) from front-end processor 312 to the back-end processor 314 for settlement. Back-end processor may generate ACH files for merchant settlement. Acquirer may submit settlement files (325S, 327S) to Issuer 318 for reimbursement via association/interchange 316. Issuer 318 may post the transaction and pay merchant 304 (329S, 331S, 333S).

It is during this authorization and clearing and settlement processes that the additional FPAN may be used to ensure a double-blind transaction as described in FIG. 5.

With respect to a merchant and a PoS device, FIG. 4 illustrates an example PoS device 400. PoS device 400 may include a controller 402, a reader interface 404, a data interface 406, a smartcard reader 408, a magnetic stripe reader 410, a near-field communications (NFC) reader 412, a power manager 414, a keypad 416, an audio interface 418, a touchscreen/display controller 420, and a display 422. Also, PoS device 400 may be coupled with, integrated into or otherwise connected with a cash register/retail enterprise system 424.

In various embodiments, Controller 402 may be any controller or processor capable of controlling the operations of PoS device 400. For example, controller 402 may be an Intel® 2nd Generation Core™ i3 or i5 or Pentium™ G850 processor or the like. Controller 402 also may be a controller included in a personal computer, smartphone device, tablet PC or the like.

Reader interface 404 may provide an interface between the various reader devices associated with PoS device 400 and PoS device 400. For example, reader interface 404 may provide an interface between smartcard reader 408, magnetic stripe reader 410, NFC reader 412 and controller 402. In various embodiments, reader interface 404 may be a wired interface such as a USB, RS232 or RS485 interface and the like. Reader interface 404 also may be a wireless interface and implement technologies such as Bluetooth, the 802.11(x) wireless specifications and the like. Reader interface 404 may enable communication of information read by the various reader devices from the various reader devices to PoS device 400 to enable transactions. For example, reader interface 404 may enable communication of a credit or debit card number read by a reader device from that device to PoS device 400. As another example, reader interface 404 may enable communication of an additional FPAN (e.g., FPAN2, FPAN3) from a card and/or transaction device to a PoS device 400. In various embodiments, reader interface 404 may interface between PoS device 400 and other devices that do not necessarily “read” information but instead receive information from other devices.

Data interface 406 may allow PoS device 400 to pass communicate data throughout PoS device and with other devices including, for example, cash register/retail enterprise system 424. Data interface 406 may enable PoS device 400 to integrate with various customer resource management (CRM) and/or enterprise resource management (ERP) systems. Data interface 406 may include hardware, firmware and software that make aspects of data interface 406 a wired interface. Data interface 406 also may include hardware, firmware and software that make aspects of data interface 606 a wireless interface. In various embodiments, data interface 406 also enables communication between PoS device other devices.

Smartcard reader 648 may be any electronic data input device that reads data from a smart card, such as for example, an additional FPAN (e.g., FPAN2, FPAN3, etc.). Smartcard reader 408 may be capable of supplying an integrated circuit on the smart card with electricity and communicating with the smart card via protocols, thereby enabling read and write functions. In various embodiments, smartcard reader 408 may enable reading from contact or contactless smart cards. Smartcard reader 408 also may communicate using standard protocols including ISO/IEC 7816, ISO/IEC 14443 and/or the like or proprietary protocols.

Magnetic stripe reader 410 may be any electronic data input device that reads data from a magnetic stripe on a credit or debit card, for example. In various embodiments, magnetic stripe reader 410 may include a magnetic reading head capable of reading information from a magnetic stripe, such as, for example, and additional FPAN (e.g., FPAN2, FPAN3, etc.). Magnetic stripe reader 410 may be capable of reading, for example, cardholder information from tracks 1, 2, and 3 on magnetic cards. In various embodiments, track 1 may be written on a card with code known as DEC SIXBIT plus odd parity and the information on track 1 may be contained in several formats (e.g., format A, which may be reserved for proprietary use of the card issuer; format B; format C-M which may be reserved for us by ANSI subcommittee X3B10; and format N-Z, which may be available for use by individual card issuers). In various embodiments, track 2 may be written with a 5-bit scheme (4 data bits plus 1 parity). Track 3 may be unused on the magnetic stripe. In various embodiments, track 3 transmission channels may be used for transmitting dynamic data packet information to further enable enhanced token-based payments.

NFC reader 412 may be any electronic data input device that reads data from a NFC device. In an exemplary embodiment, NFC reader 412 may enable Industry Standard NFC Payment Transmission. For example, the NFC reader 412 may communicate with a NFC enabled device to enable two loop antennas to form an air-core transformer when placed near one another by using magnetic induction. NFC reader 412 may operate at 13.56 MHz or any other acceptable frequency. Also, NFC reader 412 may enable a passive communication mode, where an initiator device provides a carrier field, permitting answers by the target device via modulation of existing fields. Additionally, NFC reader 412 also may enable an active communication mode by allowing alternate field generation by the initiator and target devices.

In various embodiments, NFC reader 412 may deactivate an RF field while awaiting data. NFC reader 412 may receive communications containing Miller-type coding with varying modulations, including 100% modulation. NFC reader 412 also may receive communications containing Manchester coding with varying modulations, including a modulation ratio of approximately 10%, for example. Additionally, NFC reader 412 may be capable of receiving and transmitting data at the same time, as well as checking for potential collisions when the transmitted signal and received signal frequencies differ.

NFC reader 412 may be capable of utilizing standardized transmission protocols, for example but not by way of limitation, ISO/IEC 14443 A/B, ISO/IEC 18092, MiFare, FeliCa, tag/smartcard emulation, and the like. Also, NFC reader 412 may be able to utilize transmission protocols and methods that are developed in the future using other frequencies or modes of transmission. NFC reader 412 also may be backwards-compatible with existing payment techniques, such as, for example RFID. Also, NFC reader 412 may support transmission requirements to meet new and evolving payment standards including internet based transmission triggered by NFC. In various embodiments, NFC reader 412 may utilize MasterCard's® PayPass and/or Visa's® PayWave and/or American Express'® ExpressPay systems to enable transactions.

Although not shown and described, other input devices and/or readers, such as for example, barcode readers and the like are contemplated.

Power manager 414 may be any microcontroller or integrated circuit that governs power functions of PoS device 400. Power manager 414 may include, for example, firmware, software, memory, a CPU, a CPU, input/output functions, timers to measure intervals of time, as well as analog to digital converters to measure the voltages of the main battery or power source of PoS device 400. In various embodiments, Power manager 414 remains active even when PoS device 400 is completely shut down, unused, and/or powered by the backup battery. Power manager 414 may be responsible for coordinating many functions, including, for example, monitoring power connections and battery charges, charging batteries when necessary, controlling power to other integrated circuits within PoS device 400 and/or other peripherals and/or readers, shutting down unnecessary system components when they are left idle, controlling sleep and power functions (on and off), managing the interface for built-in keypad and trackpads, and/or regulating a real-time clock (RTC).

Keypad 416 may any input device that includes a set of buttons arranged, for example, in a block or pad and may bear digits, symbols and/or alphabetical letters. Keypad 416 may be a hardware-based or mechanical-type keypad and/or implemented in software and displayed on, for example, a screen or touch screen to form a keypad. Keypad 416 may receive input from a user that pushed or otherwise activates one or more buttons on keypad 416 to provide input.

Audio interface 418 may be any device capable of providing audio signals from PoS device 400. For example, audio interface may be a speaker or speakers that may produce audio signals. In various embodiments, audio interface 418 may be integrated within PoS device 400. Audio interface 418 also may include components that are external to PoS device 400.

Touchscreen/display control 420 may be any device or controller that controls an electronic visual display. Touchscreen/display control 420 may allow a user to interact with PoS device 400 through simple or multi-touch gestures by touching a screen or display (e.g., display 422). Touchscreen/display control 420 may be configured to control any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, touchscreen/display control 420 may receive inputs from the touchscreen and process the received inputs. Touchscreen/display control 420 also may control the display on PoS device 400, thereby providing the graphical user interface on a display to a user of PoS device 400.

Display 422 may be any display suitable for a PoS device. For example, display 422 may be a TFT, LCD, LED or other display. Display 422 also may be a touchscreen display that for example allows a user to interact with PoS device 400 through simple or multi-touch gestures by touching a screen or display (e.g., display 422). Display 422 may include any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, 422 may receive inputs from control gestures provided by a user. Display 422 also may display images, thereby providing the graphical user interface to a user of PoS device 400.

Cash register/retail enterprise system 424 may me any device or devices that cooperate with PoS device 400 to process transactions. Cash register/retail enterprise system 424 may be coupled with other components of PoS device 400 via, for example, a data interface (e.g., data interface 406) as illustrated in FIG. 4. Cash register/retail enterprise system 424 also may be integrated into PoS device 400.

FIG. 5 depicts an example method performed using the systems described in FIGS. 1 through 4. Throughout the description of FIG. 5, FPAN2 will be used for exemplary purposes only. Any additional FPAN(s) may be included and/or substituted in for FPAN2 in each of the method steps.

The method may begin at step 502. At step 504, a FPAN2 token may be received at a merchant system from an account holder device. The account holder device may store and/or be enabled to transmit tokenized FPAN2 s associated with a particular transaction card (e.g., credit card, debit card, prepaid card, etc.). In various embodiments, the tokenized FPAN2 is not associated with the number printed on the face of the associated transaction card (e.g., a credit card number), but instead is an additional FPAN associated with the transaction card and particular merchant, for example. Once a merchant system has received the tokenized FPAN2, the merchant system may transmit the tokenized FPAN2 and a merchant identifier to an association and/or interchange system in step 506. The association and/or interchange system may convert the tokenized FPAN2 to an FPAN2 in step 508 using decryption and/or decoding technologies associated with secured data transfers. In another example, the association and/or interchange system may transmit the tokenized FPAN2 to a financial institution system where the tokenized FPANs may be converted into an FPAN2 using decryption and/or decoding technologies associated with secured data transfers.

Once the tokenized FPAN2 has been converted into an FPAN2, it may be compared with the anticipated FPAN2 based on the merchant identifier in step 510. For example, when an association and/or interchange system and/or financial institution performs the comparison, the association and/or interchange system and/or financial institution may look up an FPAN2 associated with the merchant identifier and compare the stored FPAN2 associated with the merchant identifier with the converted tokenized FPAN2. In step 512, the results of the comparison, either affirming a correct converted FPAN2 or rejecting an incorrect converted FPAN.

When a system determines the converted FPAN2 is incorrect, a transaction may be denied at step 514. Additionally, a message and/or alert may be transmitted to an account holder device, merchant system, association/interchange system, and/or financial institution system. An alert may trigger fraud protection functionality at a financial institution and/or association/interchange system. A message may be sent to a merchant system and/or account holder device indicating that a potential fraudulent transaction has occurred. A message and/or alert may include the tokenized FPAN2, merchant identifier, and/or a date/time stamp associated with the fraudulent transaction. Once the transaction has been denied, the method may end at step 516.

When a system determines the converted FPAN2 is correct, the system may determine a primary account number associated with the FPAN2 in the 518. The system, whether it is an association/interchange system or a financial institution system, may compare the FPAN2 with stored FPAN2 s and associated primary account numbers and return the primary account number associated with the FPAN2. If an association/interchange system determines the primary account number, the primary account number may be transmitted to the card issuer financial institution for transaction processing in step 520. A card issuing financial institution may then process the financial transaction for the primary account number and perform the necessary account debits and/or credits. Once the financial transaction has been processed at the financial institution and/or association/interchange system, the tokenized FPAN2 may be transmitted with transaction details back to the merchant system and/or account holder device. In this manner, the primary account number is never transmitted between the account holder and the merchant systems.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It may be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It may be further understood by those within the art that if a specific number of an introduced claim recitation is intended, such an intent may be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It may be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” may be understood to include the possibilities of “A” or “B” or “A and B.”

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

In the preceding specification, various preferred embodiments have been described with references to the accompanying drawings. It may, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

I claim:

1. A method, comprising:
receiving, via a network at a funding personal account number (FPAN) processor of an interchange system, a tokenized secondary FPAN and a merchant identifier;
converting, using the FPAN processor, the tokenized secondary FPAN to a secondary FPAN;
comparing, using the FPAN processor, the secondary FPAN to a stored FPAN based on the merchant identifier;
determining, using the FPAN processor, a primary account number when the secondary FPAN matches the stored FPAN;
transmitting, via a network using an input/output interface of the interchange system, the primary account number to an issuing financial institution for transaction processing;
receiving, via the network at the input/output interface of the interchange system, a transaction processing result; and
transmitting, via the network at the input/output interface of the interchange system, the transaction processing result with the tokenized secondary FPAN to a merchant system.

2. The method of claim 1, wherein the tokenized secondary FPAN and merchant identifier are received from the merchant system.

3. The method of claim 1, wherein the merchant system includes a point of sale device that enables transmission of the tokenized secondary FPAN and merchant identifier to the interchange system.

4. The method of claim 1, wherein the interchange system is a transaction authorization network.

5. The method of claim 1, wherein the primary account number is not discoverable by the merchant system.

6. The method of claim 1, wherein the secondary FPAN is neither the FPAN nor the primary account number.

7. The method of claim 1, wherein the issuing financial institution includes a FPAN processor and an authorization system to determine the transaction processing result.

8. The method of claim 7, wherein the issuing financial institution includes an input/output interface that transmits the transaction processing result to the interchange system.

9. The method of claim 1, wherein the comparing includes accessing a data storage associated with the interchange system and retrieving the stored FPAN.

10. The method of claim 1, wherein the tokenized secondary FPAN is a pseudorandom number.

11. A system, comprising:
a network; and
an interchange system that is connected to a merchant system and an issuing financial institution via the network, the interchange system including:
a funding personal account number (FPAN) processor that receives, via the network, a tokenized secondary FPAN and a merchant identifier, converts the tokenized secondary FPAN to a secondary FPAN, compares the secondary FPAN to a stored FPAN based on the merchant identifier, and determines a primary account number when the secondary FPAN matches the stored FPAN; and
an input/output interface that transmits, via the network, the primary account number to the issuing financial institution for transaction processing, receives via the network, a transaction processing result, and transmits the transaction processing result with the tokenized secondary FPAN to the merchant system.

12. The system of claim 11, wherein the tokenized secondary FPAN and merchant identifier are received via the network from the merchant system.

13. The system of claim 11, wherein the merchant system includes a point of sale device that enables transmission of the tokenized secondary FPAN and merchant identifier to the interchange system.

14. The system of claim 11, wherein the interchange system is a transaction authorization network.

15. The system of claim 11, wherein the primary account number is not discoverable by the merchant system.

16. The system of claim 11, wherein the secondary FPAN is neither the FPAN nor the primary account number.

17. The system of claim 11, wherein the issuing financial institution includes a FPAN processor and an authorization system to determine the transaction processing result.

18. The system of claim 17, wherein the issuing financial institution includes an input/output interface that transmits the transaction processing result to the interchange system.

19. The system of claim 11, wherein the FPAN processor accesses a data storage associated with the interchange system and retrieving the stored FPAN.

20. The system of claim 11, wherein the tokenized secondary FPAN is a pseudorandom number.
